(19) United States
(12) Patent Application Publication
(10) Pub. No.: US 2002/0032754 A1
(43) Pub. Date: Mar. 14, 2002

(54) Method and apparatus for profiling in a distributed application environment

(76) Inventors: Gary Logston, Poway, CA (US); Patrick Ladd, San Marcos, CA (US)

Correspondence Address: GAZDZINSKI & ASSOCIATES, Suite A232, 3914 Murphy Canyon Road, San Diego, CA, 92123, US

(21) Appl. No.: 09/826,201

(22) Filed: Apr. 4, 2001

Related U.S. Application Data
(60) Provisional application No. 60/194,953, filed on Apr. 5, 2000.

(51) Int. Cl. G06F 15/16

(52) U.S. Cl. 709/219; 709/203

(57) ABSTRACT

An improved method and apparatus for deriving and characterizing the resource capabilities of client devices in a distributed application (DA) network environment. In a first aspect of the invention, a method and associated architecture for obtaining client device configuration and resource information are disclosed which incorporate a distributed profiling entity having a server portion and client portion, the client portion being used to facilitate query of the client device, and transfer of device resource and configuration information back to the server portion. This information is later used by the profiling entity to alter and update the distribution of entity components between the server and client device. The client device configuration may also be altered if required. In a second aspect of the invention, a method of scaling the aforementioned distributed profiling entity during both initial download and after initiation is disclosed.

### RELATED APPLICATIONS

The present application claims priority benefit of U.S. provisional application Serial No. 60/194,953 filed Apr. 5, 2000 and entitled “Method And Apparatus For Profiling In A Distributed Application Environment”, which is incorporated herein in its entirety.

The present application is related to co-pending U.S. patent application Ser. No. 09/583,064 filed May 30, 2000 entitled “Method and Apparatus for Balancing Distributed Applications” and assigned to the Assignee hereof.

### BACKGROUND OF THE INVENTION

1. Field of the Invention

The present invention relates generally to the field of software applications that are distributed over an information network, and specifically to the distribution and division of applications software program code and other associated components between the client device(s) and server(s) on the network.

2. Description of Related Technology

Client-server network architectures are well known in the data networking arts. As used in the present disclosure, the term “network” broadly includes cable television networks, direct broadcast satellite (DBS) networks, imaging or positioning satellite networks, television broadcast networks, local- and wide-area data networks (LANs and WANs), storage area networks (SANs), networks comprising interconnected distinct CPU-memory units performing parallel processing as separate servers or as one distributed aggregate server, as well as other communications and data networks, regardless of whether wired, optical, or wireless. Often, there is a need to divide the software associated with such client-server systems into multiple components which are distributed across one or more devices of the network. A Distributed Application (DA) is a computer program that is broken into such multiple components. These components are then distributed as client and server portions of the distributed application, hereinafter known as the Distributed Application Client Portion (DACP) and the Distributed Application Server Portion (DASP).

Typically, client devices, hereinafter also known as “the client”, will have significantly less processing power, memory and data storage capabilities (hereafter known as a “resource capability profile” or “profile”) than a server machine (“the server”). Examples of client devices, whether connected to the network either wired (metallic or optically) or wirelessly, include set-top boxes, digital televisions, networked personal computers (PCs), handheld computers, internet or communications appliances, GPS devices, cellular telephones, and personal digital assistants (PDAs). A client device can be any electronic device comprising any combination of hardware and software whose functionality includes processing, data storage, input, output, decoding, encoding, transmitting, receiving, graphics generation, visual display, or audio output. The DACP will be considered “thin”, meaning that it will generally have minimal functional capabilities or limited resource profiles so as to minimize the resource burden placed on the client device. Therefore, most of the distributed application will run on the server or another remote processing device, the configuration of which is selected so as to be capable of handling the needs of multiple DACPs simultaneously. Hence, a single DASP can handle processing for multiple DACPs for the same application. In addition, a single server can run as many DASPs as its hardware and operating system constraints will allow. A server may run multiple DASPs for the same or different applications simultaneously.

In general, the server downloads the DACP to the client device(s) upon the occurrence of a specified event, such as the client device user selecting a function on their client device. The author of the distributed application software determines how processing will be divided between the DASP and the DACP at run-time. The DACP is, for example, often limited to handling only input/output (I/O) and graphics functionality on the client device. The DACP places consumer input data into messages of a predetermined protocol and sends them to the distributed application server for processing. FIG. 1 demonstrates the foregoing distributed application model for a single client-server relationship. It will be recognized that while a single client-server architecture is shown in FIG. 1, a typical client server network comprises a plurality of servers and clients, whereby each server and client type may have a different resource profile

With the advent of digital cable systems that provide downloadable software applications and reverse communications with entities such as cable television multi-system operator (MSO) head-ends and the Internet, set-top box and client device resource requirements have risen dramatically. Downloadable software applications taking fill advantage of resources defined in standards such as CableLab's OCAP (OpenCable Application Platform) specification, ATVEF's (Advanced Television Enhancement Forum) Enhanced Content Specification, ATSC's (Advanced Television Systems Committee) DASE (Digital television Applications Software Environment) specification, and DVB's (Digital Video Broadcasting) MHP (Multimedia Home Platform) specification. These client specifications can demand considerable CPU, memory, and storage resources, which leads to greater client device (in this case, a set-top box) complexity and cost.

Similarly, with the advent of wireless data networks, which anticipate both fixed and mobile usage of varied functionality client devices associated with these networks, downloadable software applications taking full advantage of wireless access protocol specifications and client device specifications can demand considerable CPU, memory, and storage resources, again leading to greater client device complexity and cost.

In order to allow for the operation of such resource-intensive software applications while using only the minimum profile client devices, a technique is needed to dynamically off-load or allocate portions of the application execution to server processes not residing in the client device. Existing prior art distributed applications do not permit such dynamic allocation or “scaling” between the server and client portions, especially based on the client device resource configuration, thereby requiring careful consideration of the client device configuration during development of the distributed application. For example, the well-known prior art CORBA (Common Object Request Broker Architecture) environment is a non-scaling three-tiered system. The three tiers of the CORBA system consist of a user interface (UI) tier, computational processing tier, and database tier. The client device employs a graphical user interface (GUI) as the UI tier. One or more servers containing the processing tier and the database tier are also employed in this system. This three-tier approach does not, however, provide any facility for scaling of the distributed application between the server(s) and client device(s), whether based on client device configuration or other parameters. Specifically, such multi-tier systems do not define or include the ability to move applications software code objects around dynamically at runtime, in order to make a client “thinner” or “fatter” based on the resource capability of the client.

Similarly, the well known COM⁺ and DCOM systems produced by Microsoft Corporation provide templates or frameworks for the server and client pieces. COM (including DCOM) is a binary compatibility specification and associated implementation that allows clients to invoke services provided by COM-compliant components (i.e., COM objects). Services implemented by COM objects are exposed through a set of interfaces; these interfaces represent the single point of contact between clients and the object. COM defines a binary structure for these interfaces; this binary structure provides for interoperability between software components written in arbitrary languages. COM objects and clients can be coded in any language that supports Microsoft's COM binary structure. A COM object can also support any number of interfaces. COM objects and interfaces are specified using Microsoft Interface Definition Language (IDL), which is an extension of the DCE Interface Definition Language standard.

However, COM Interfaces are considered logically immutable. Once an interface is defined, it should not be changed (i.e., new methods should not be added and existing methods should not be modified). This restriction removes the potential for version incompatibility, but also significantly restricts the application developer. Additionally, the frameworks provided by COM/DCOM are not automatically self-distributing, and do not provide for distributed application scaling or dynamic movement of objects based on resource capability at runtime. These limitations are particularly debilitating, since the equipment configuration and available resources associated with the client device(s) may change between operating periods, and potentially even during a single period of device operation.

Based on the foregoing, there is a need for an improved method and apparatus for client device profiling in a distributed application environment. Specifically, such an improved method and apparatus would be able to dynamically scale portions of the execution of the distributed application software code between the client device(s) and server(s) on the network, ideally based on device configuration or other pertinent information determined dynamically at runtime or thereafter. Such improved method and apparatus would also ideally be readily adaptable to a number of different client device hardware environments including set-top boxes, video game players, personal video recorders, DVD players, digital televisions, networked personal computers, handheld computers, internet or communications appliances, GPS devices, over-the-air RF modems, RF cable modems, XDSL modems, voiceband data modems, cellular or personal communications telephones, personal digital assistants (PDAs), which are operating in cable, satellite, telephone or other terrestrial wired or wireless networks. Such improved method and apparatus would also be effectively transparent to the end user of such client devices.

### SUMMARY OF THE INVENTION

The present invention satisfies the aforementioned needs by providing an improved method and apparatus for profiling in a distributed application environment.

In a first aspect of the invention, a method of obtaining information regarding the configuration and resources of a client device within a client-server network environment is disclosed. The method generally comprises downloading a portion of a distributed application to a client device; starting the downloaded portion; querying the client device for configuration information; and transmitting the client device information to the server portion. In one exemplary embodiment, the network is a cable television network, and the client device comprises a digital set-top box or terminal device such as a digital cable-ready television set.

In another exemplary embodiment, the client device comprises a server component distinct from the server portion (DASP) of the distributed application (e.g., within the same physical server but partitioned with respect to the DASP, within another server of the same farm, or within another server farm remotely located) to which a client portion of the distributed application is downloaded. Accordingly, the “remote” server component acts as a client to which DA components or other applications may be downloaded.

In a second aspect of the invention, a method of establishing a communication channel between the aforementioned client and server portions of the distributed application is disclosed. The method generally comprises attempting to establish a communication channel using a first communication mode; determining the configuration of the server end communication equipment when communication via the first mode can not be established; and downloading a communication module to the client capable of establishing communication between the client and server via a second communication mode; and establishing a communication channel via the second mode.

In a third aspect of the invention, a method of scaling or allocating the aforementioned distributed application is disclosed. The method generally comprises apportioning the distributed application into a plurality of portions; selecting a subset of the plurality of portions to download to a client device; downloading the selected subset of portions to the client device; testing the functionality of the client device portions; and downloading additional portions of the plurality to the client device if the client device functionality is not established.

In a fourth aspect of the invention, a distributed application architecture for implementing the aforementioned methods is disclosed. In one exemplary embodiment, the architecture comprises a distributed profiling software entity having distributed application server portions (DASPs) and client portions (DACPs) distributed to the network server(s) and client device(s) respectively. The client portion is adapted to query and receive information from the client device, which is transmitted or otherwise provided to the server. A database is operatively coupled to the server portion (which includes management and controller portions) wherein the client device and client profile information is stored. The architecture further includes an authoring editor which facilitates the authoring of distributed applications adapted for scaling as previously described.

In another exemplary embodiment of the present invention, the network comprises the wired or wireless communication paths or data buses interconnecting a first server or portion of said first server (collectively, the “master server”) with a different portion of the same server, or alternatively a separate second server or portion of said separate second server (collectively, the “slave server”), the slave server effectively acting as a client device with respect to the master server. The slave server is profiled as other client devices having resource configurations or functionality which is thinner relative to, in this embodiment, the master server.

### BRIEF DESCRIPTION OF THE DRAWINGS

FIG. 1 is block diagram illustrating a typical client-server relationship on a prior art information network.

FIG. 2 is a block diagram illustrating one exemplary embodiment of a distributed application profiling entity server portion (DASP) servicing two associated client portions (DACPs) via a hybrid fiber-coaxial network according to the invention.

FIG. 2a is a block diagram illustrating another embodiment of the distributed application profiling entity server portion (DASP), wherein a separate server portion within the same physical server device acts as a client to the “master” server portion.

FIG. 2b is a block diagram illustrating another embodiment of the distributed application profiling entity server portion (DASP), wherein a separate server portion within a different server device acts as a client to the “master” server portion.

FIG. 3 is a block diagram illustrating one exemplary architecture for the head-end Manager DASP, SMS Monitor DASP, Controller DASP, SMS Database, and the DACP according to the invention.

FIG. 4 is a logical flow diagram illustrating the method of profiling client devices in a distributed application environment according to the invention.

FIG. 4a is a logical flow diagram illustrating one exemplary embodiment of the method of establishing a communication channel between a server and one or more client devices according to the invention.

FIG. 5 is a block diagram illustrating the relationship of various components within one exemplary distributed application including the message protocol (MP) and vertical splitting of the application.

FIG. 6 is a logical flow diagram illustrating one embodiment of the method of scaling a distributed application between server and client(s) according to the invention.

FIG. 7 is a logical block diagram illustrating one exemplary embodiment of distributed application server portion (DASP) input/output layering according to the invention.

FIG. 8 is a class diagram illustrating the relationship between various software entities within an exemplary distributed application according to the invention.

FIG. 9 is a class diagram illustrating the relationship between the profiler server and profiler client of the distributed application of FIG. 8.

### DETAILED DESCRIPTION OF THE INVENTION

Reference is now made to the drawings wherein like numerals refer to like parts throughout.

### Overview

The present invention discloses apparatus and methods useful for deriving and characterizing the resource capabilities of various different types of client devices connected to a common network and operating in a distributed application (DA) environment. A Distributed Application (DA), within the context of this disclosure, is defined as a computer program that is broken into multiple components. Such breaking or partitioning of the computer program may be according to one or more parameters, such as for example along functional module boundaries, based on a maximum component size limit, etc. The components are then distributed as client and server portions of the DA; hereinafter known as Distributed Application Client Portion (DACP) and Distributed Application Server Portion (DASP). The present invention focuses primarily how client devices and other assets within the network are profiled, such profiling being directly useful in, inter alia, the balancing or distribution of the DASP and DACP across the network.

The client portions of the server/client DA are typically considered “thin” (at least relative to the server portion of the DA) meaning that they have minimal functionality, so as to minimize the resource burden placed on the client device and/or reduce the resource requirements necessary for a client device to operate on the given network (i.e., allow for a broader variety of client devices, including those with very limited resources, to be used on the network). Typically, client devices, hereinafter also known as “the client”, have significantly less processing power than a server machine (“the server”). Examples of clients include, inter alia, set-top boxes, RF cable modems, network PCs, and terminal devices such as digital television sets, networked video game players, personal video recorders (PVR(s)), DVD players, networked personal computers, handheld computers, internet or communications appliances, GPS devices, over-the-air RF modems, XDSL modems, telephone voiceband data modems, cellular or personal communications telephones, personal digital assistants (PDAs), operating in cable, satellite, telephone or other terrestrial wired or wireless networks. A client device can be any electronic device comprising any combination of hardware and software whose functionality includes processing, data storage, input, output, decoding, encoding, transmitting, receiving, graphics generation, visual display, or audio output. Due to this comparatively lower processing power, most of the DA runs on the server, which is typically powerful enough to handle the needs of multiple DACPs. That is, a single DASP can handle processing for multiple DACPs for the same application. In addition, a single server can run as many DASPs as its hardware and operating system constraints will allow. A server may run multiple DASPs for the same or different applications simultaneously, thereby allowing for a heterogeneous DA environment. Accordingly, the present invention contemplates use in any number of environments ranging from a single server running a single DASP and serving a single client device, up through a multi-server environment with a plurality of DASPs, each DASP serving multiple clients, and potentially multiple DASPs serving one client.

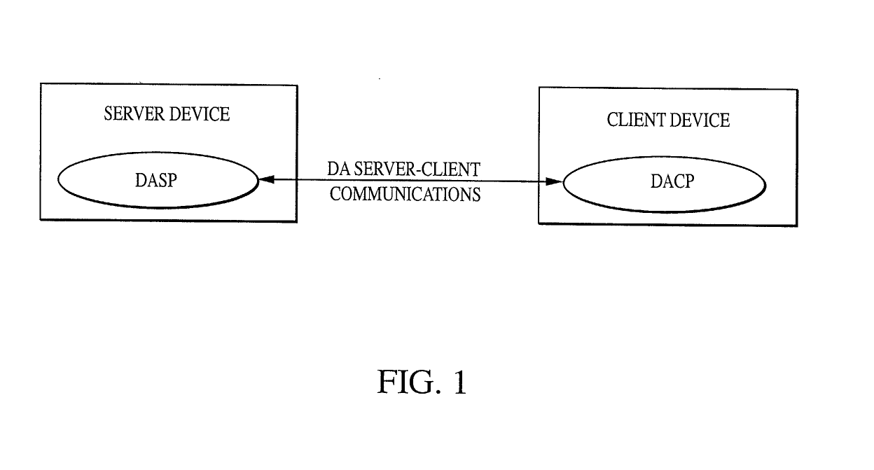

In DA architectures, the server typically downloads the DACP to the client device/s. The author of the DA determines how the DASP and DACP processing can be divided at run-time. Methods for allocating server resources and distributing DACPs and other modules are described in detail in co-pending U.S. patent application Ser. No. 09/583,064 filed May 30, 2000 and entitled “Method and Apparatus for Balancing Distributed Applications” which is assigned to the Assignee hereof, and which is incorporated herein by reference in its entirety. The DACP is often, but not always, limited to I/O (input/output) and graphics handling on the client device. The DA client places client device user input data into messages and sends them to the DA server for processing. FIG. 1 illustrates an exemplary DA architecture for a single client to server relationship.

### Distributed Application Software Terminology

As used herein, the term “application” refers generally to executable software program code (“software”) that implements theme-based functionality. The themes of applications vary broadly across any number of disciplines and functions, such as, but not limited to, home, fixed or mobile, wired or wireless e-commerce (or t-commerce) transactions, video, audio and data applications for information, communications or entertainment services (e.g. on-demand and interactive television programming, advertising, guides and menus, shopping, e-mail and chat, web browsing and searching, play-along games, voice, video or still image communications, banking and brokerage transactions, financial or investment portfolio calculation, mortgage interest calculation, etc. . . . ), and one application may have more than one theme. The executable software generally runs in a predetermined environment; for example, the software could comprise a downloadable Java Xlet™ that runs within the Java™ environment.

The term “component” refers generally to a unit or portion of executable software that is based on a related set of functionalities. For example, a component could be a single class in Java™ or C++. Similarly, the term “module” refers generally to a loosely coupled yet functionally related set of components.

As used herein, the term “process” refers generally to executable software that runs within its own CPU environment. This means that the process is scheduled to run based on a time schedule or system event. It will have its own Process Control Block (PCB) that describes it. The PCB will include items such as the call stack location, code location, scheduling priority, etc. The terms “task” and “process” are typically interchangeable with regard to computer programs.

Similarly, a “task” as used herein generally refers to a process-like entity whose PCB is referred to as a Task Control Block (TCB). A “thread” refers to a process having the same properties as a task except that it runs within a task context and uses the task's TCB. Multiple threads can run within the context of a single task. Threads are more efficient than tasks because they don't take as much time to be switched into CPU context when the task they are associated with is already running.

As used herein, the term “client process” refers generally to an executable software process that requests information and/or resources from another computer process (the server). The process typically will have its own Process Control Block (PCB) that describes it. The PCB will include items such as the call stack location, code location, scheduling priority, etc.

Lastly, a server process is an executable software process that serves various resources and information to other processes (clients) that request them, or based on other criteria (such as the occurrence of a predetermined event). The server may send resources to a client unsolicited if the client has previously registered for them, or as the DA author dictates. Note also that the server process may or may not be on the same computer as the client.

### Network Profiling Architecture

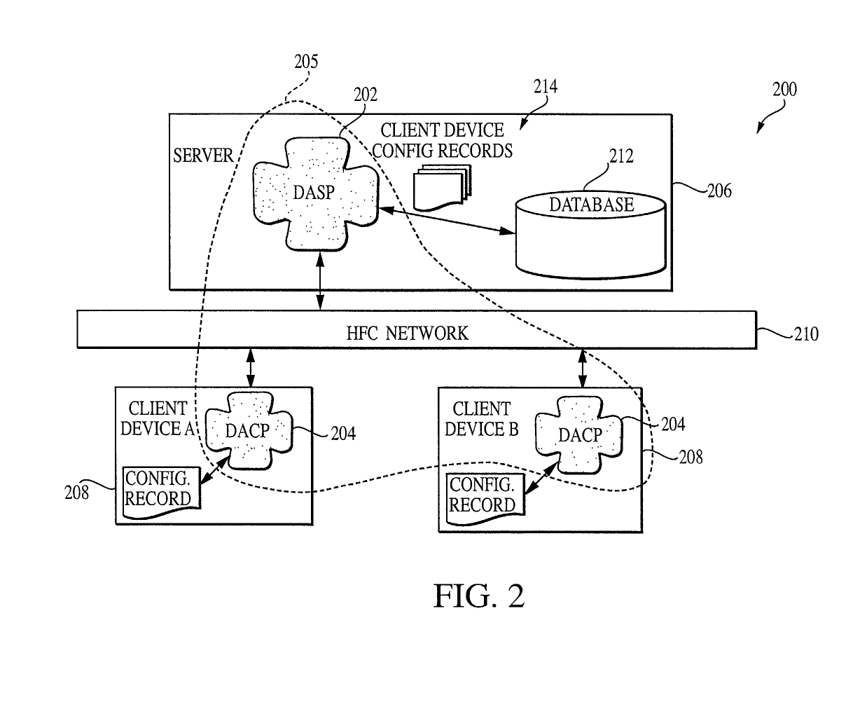

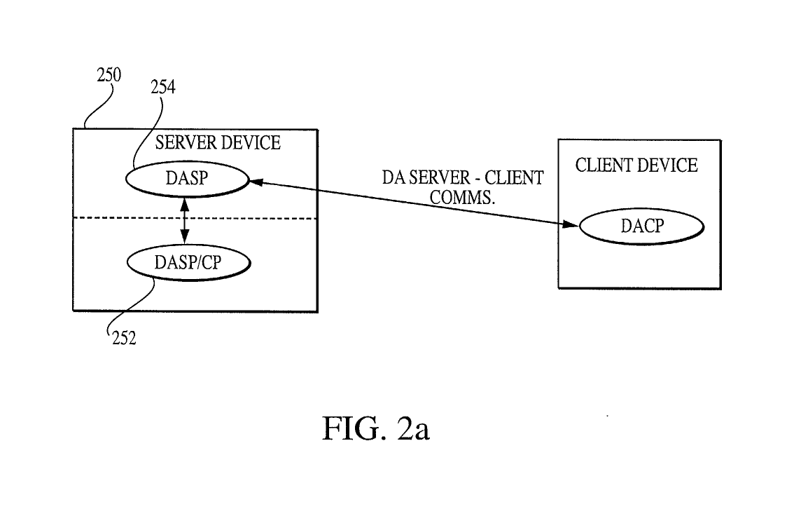

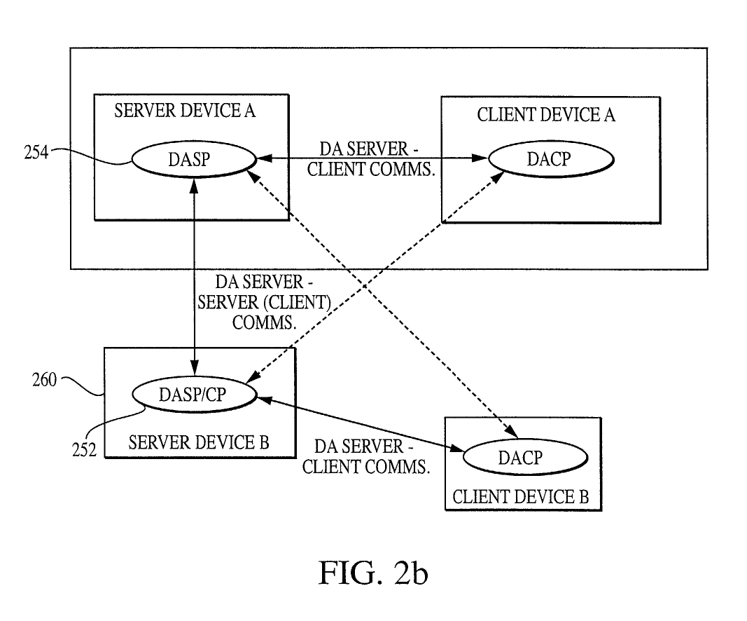

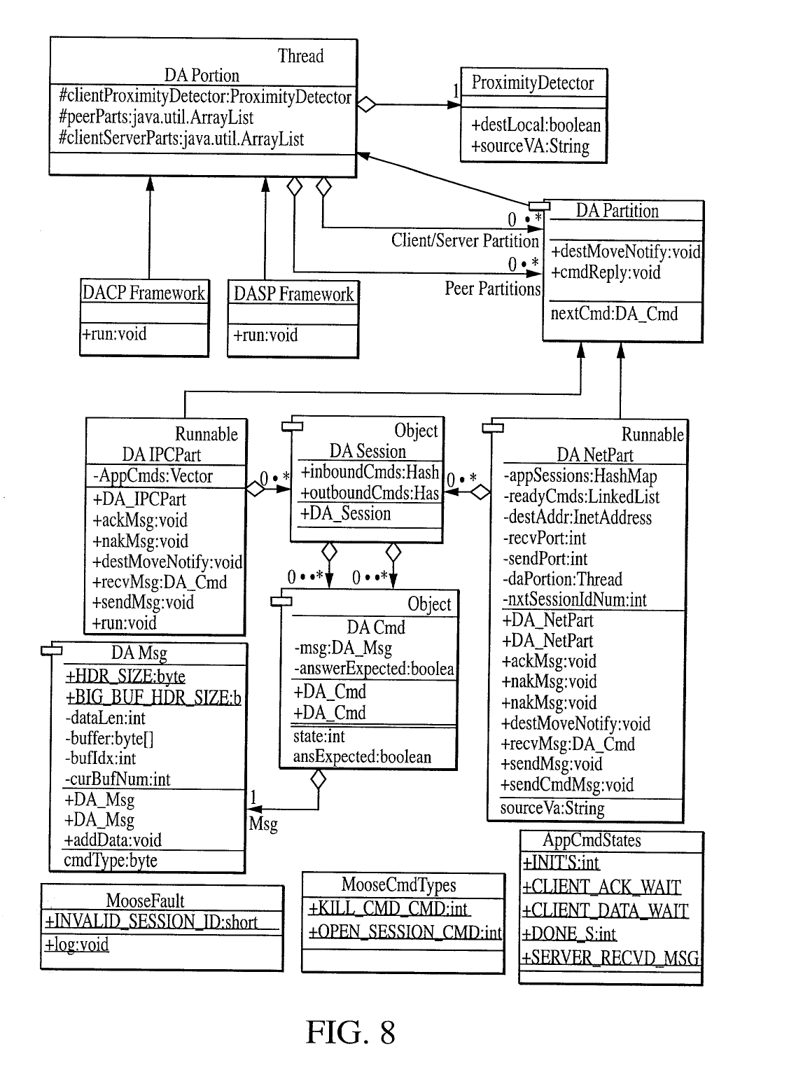

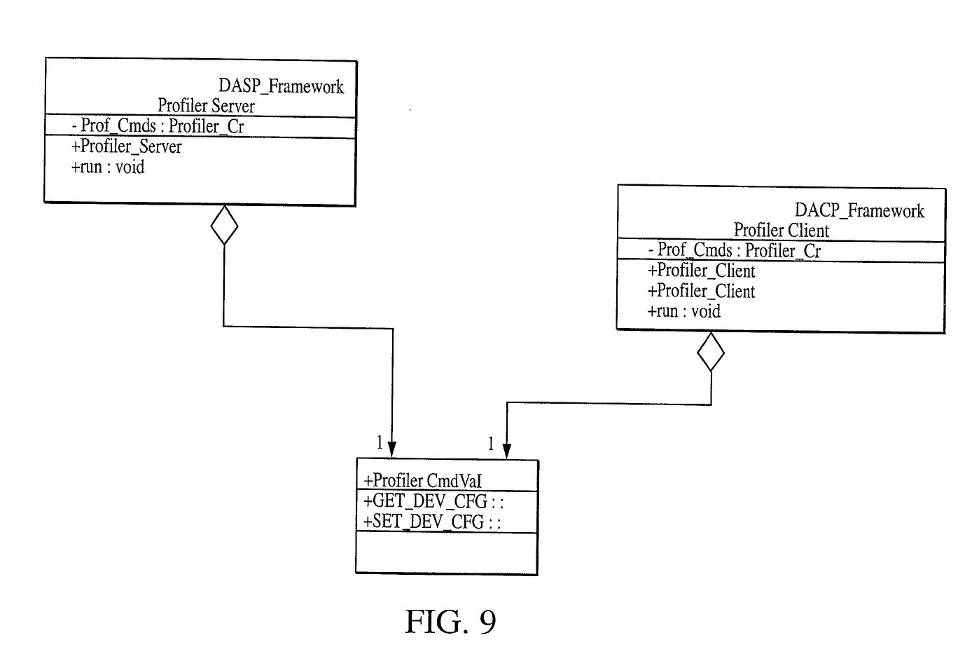

Referring now to FIG. 2, one embodiment of the network profiling architecture of the invention is described in detail. This architecture 200 generally comprises a distributed application comprising a server portion (DASP) 202 and one or more client portions (DACP) 204. When implemented using object oriented methodologies, one embodiment of the DASP 202 and the DACP 204 comprises a Profiling_Server and a Profiling_Client, respectively, as illustrated in detail in FIG. 9 herein. FIG. 8 illustrates the classes that are not application specific which the classes of FIG. 9 inherit from. It will be recognized that Java™ documents or other such embodiments derived from the code of FIG. 8 may be readily generated by those of ordinary skill in the programming arts, and accordingly are not discussed further herein.

As shown in FIG. 2, the DASP 202 is installed on the (a) network server 206 of the type well known in the art. The network server 206 is coupled to one or more of the client devices 208, which may comprise a variety of different equipment configurations such as digital set-top boxes (DSTBs) and/or terminal devices such as digital cable-ready television sets, and/or cable modems; heretofore known as client devices. Note that a variety of different configurations of client device 208 may be, and in fact are likely to be, used on the same network. The server 206 and client devices 208 are, in the illustrated embodiment, coupled via a hybrid fiber/coaxial (HFC) network 210 of the type well known in the digital cable television arts, although it will be recognized that other types of wired or wireless networks such as pure fiber-optic networks, millimeter wave RF networks and other wireless infrastructure, laser (optically coupled) networks, cell or packet-switched or routed networks, satellite networks, telephone and XDSL networks and the like may be substituted and used in conjunction with the present invention. In one common application, the network comprises a subscriber network connected to a cable tv multi-system operator (MSO) cable head-end system. As used herein, the term “head-end” refers generally to a networked system at a central location controlled by an MSO that distributes programming and services to subscribers using the cable network to client devices located at the subscribers' premises Such programming and services may include literally any information source/receiver including, inter alia, free off-the-air TV channels, pay TV channels, interactive TV, and the Internet. DSTBs may take on any configuration, and can be retail devices, meaning that consumers may or may not obtain their DSTBs from the MSO exclusively. Accordingly, it is anticipated that MSO networks may have client devices from multiple vendors, and these client devices will have widely varying hardware and processing capabilities. It will be noted, however, that a significant advantage of the distributed application profiling architecture and method of the present invention is its ability to operate both (i) independently of the hardware environment interposed between the client(s) and server(s), and (ii) with different mixes of client devices having often widely different hardware capabilities.

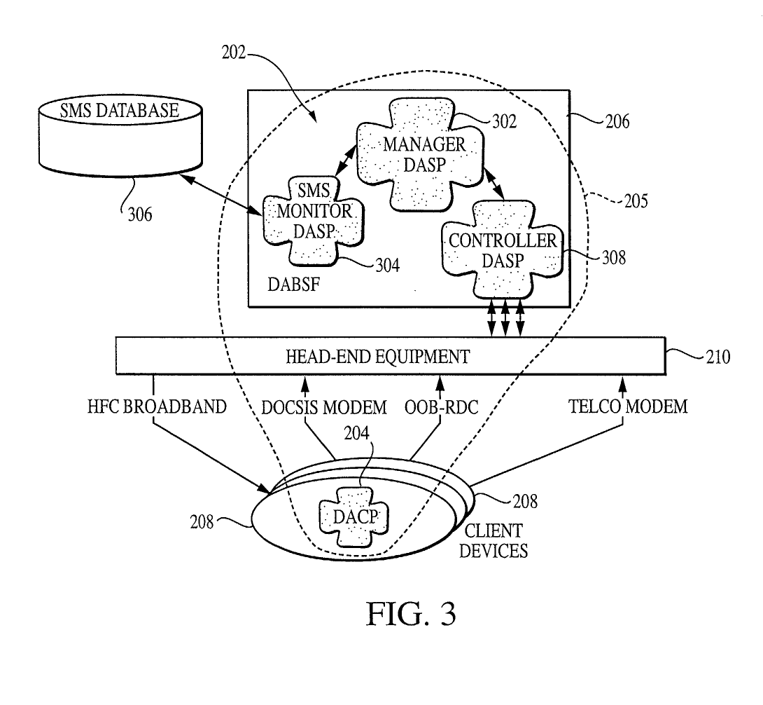

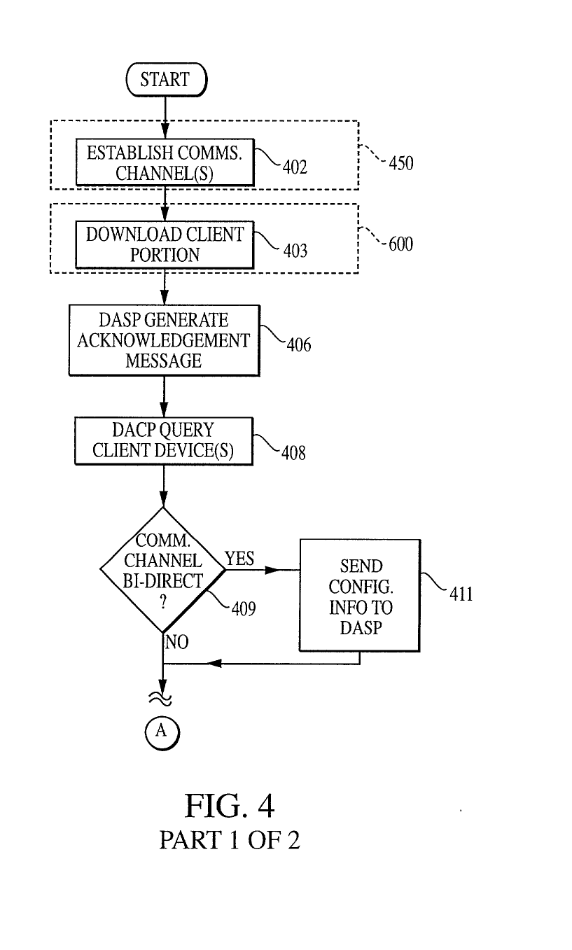

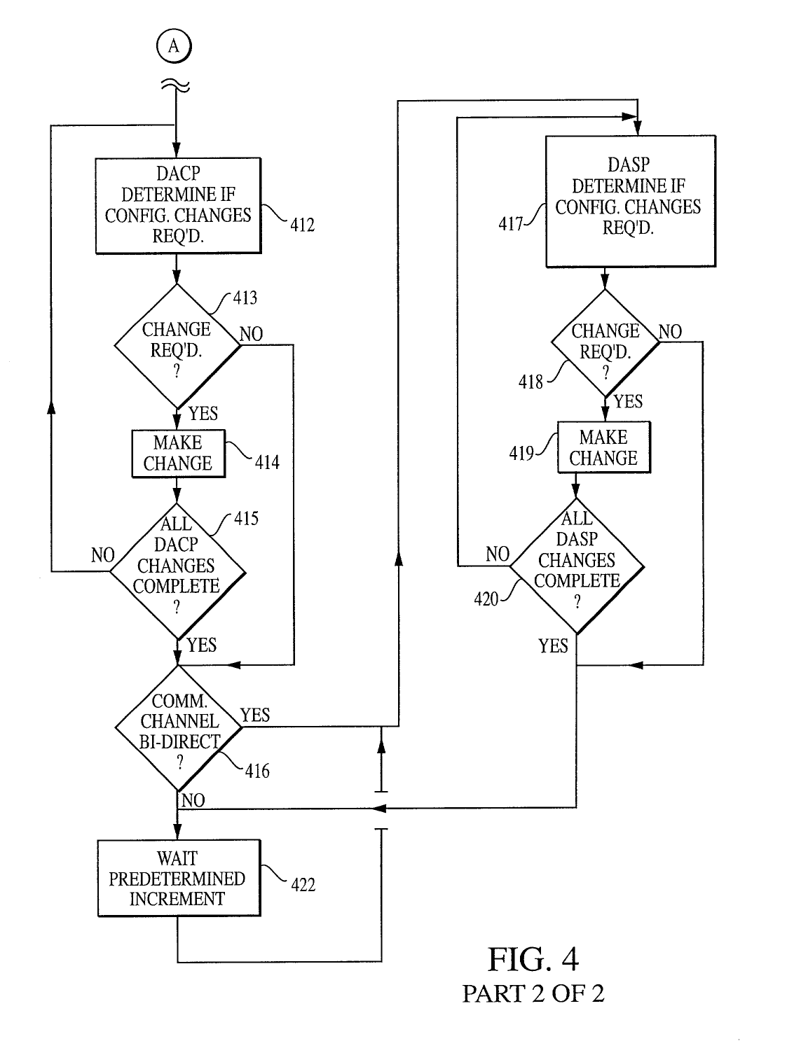

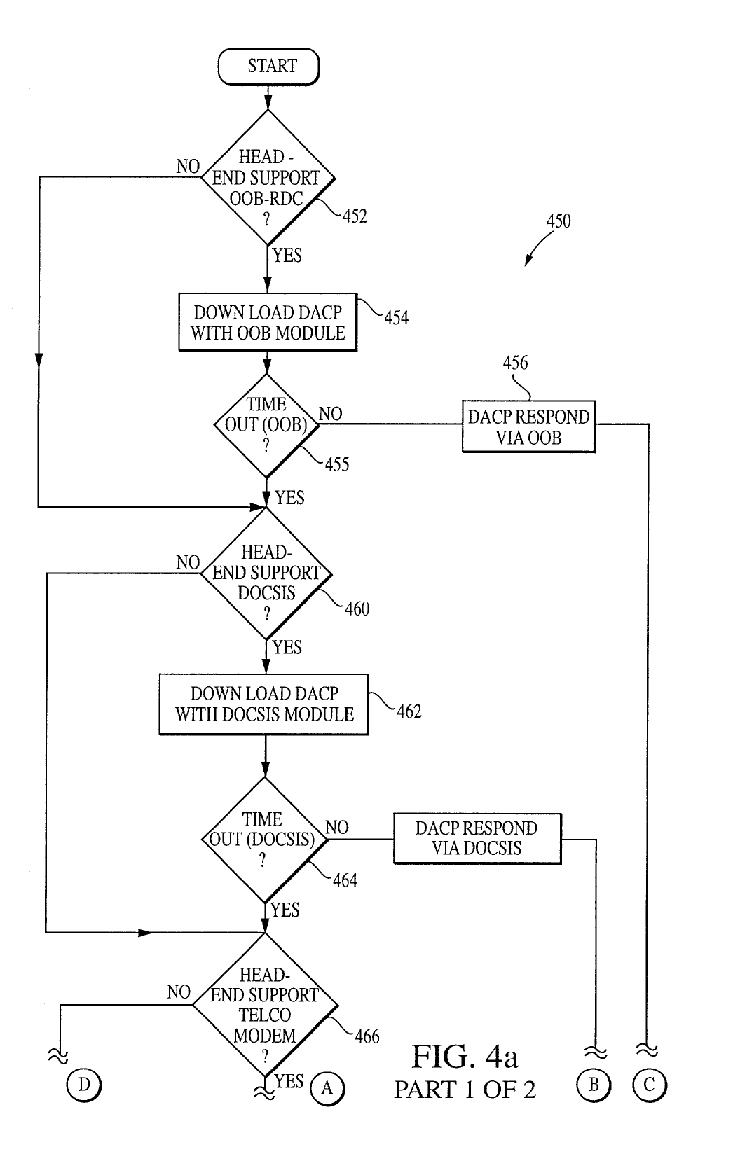

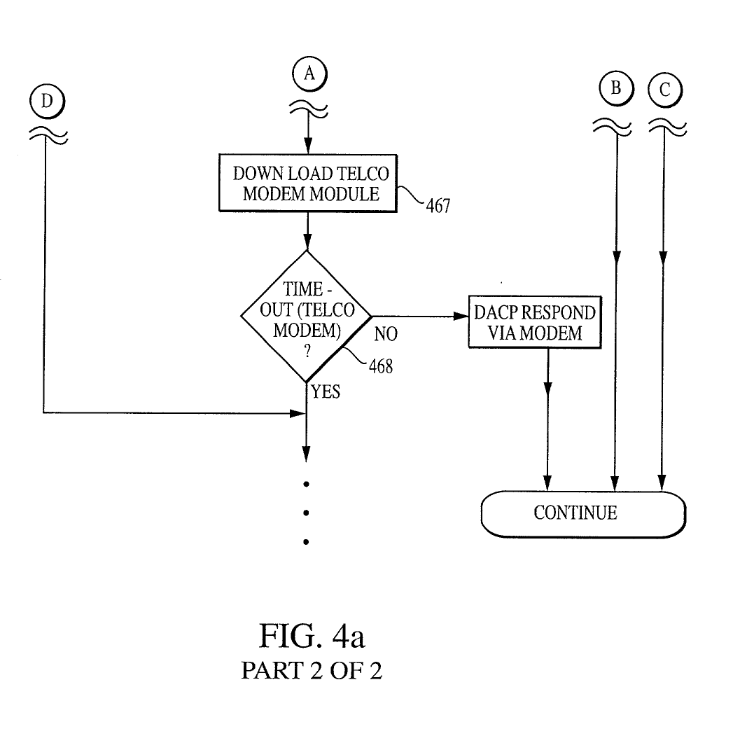

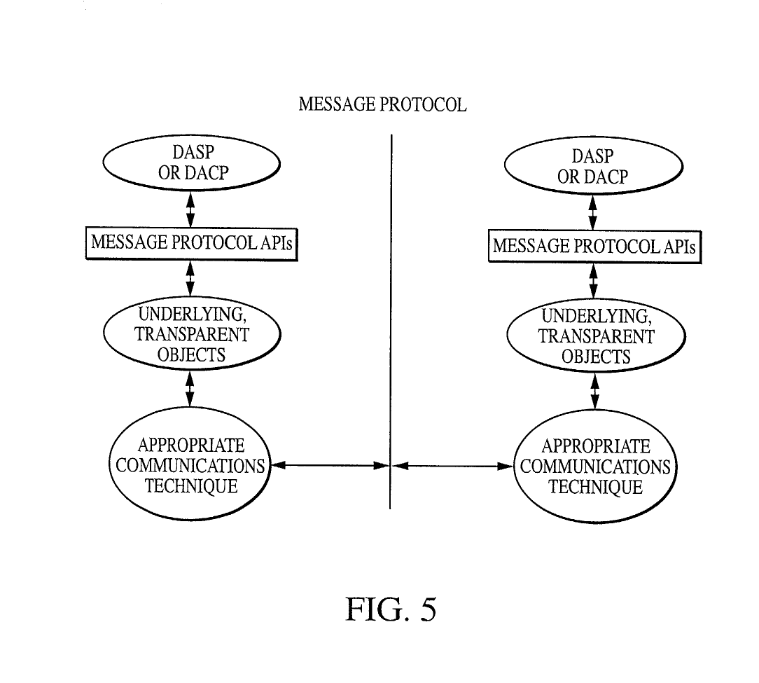

As discussed in detail with reference to FIGS. 3-4a herein, the DASP 202 and DACP 204 collectively comprise a software profiling entity 205 which is distributed across the network architecture 200. The server 206 further includes a database 212 which is used to store, inter alia, configuration records 214 containing explicit configuration information about the client devices 208 on the network. These configuration records are generated by the DACP 204 as described further below. Scaling (i.e., allocation of components or modules) of the profiling entity 205 across the various network entities is accomplished using the scaling methodology of FIG. 5 herein, although it will be appreciated that other methodologies may be substituted if desired.

Referring now to FIGS. 2a and 2b, alternate embodiments of the network profiling architecture of the invention are described. In the architecture of FIG. 2a, a separate server portion 252 within the same physical server device 250 as that supporting the DASP, acts as a client to the “master” server portion 254. This separate server portion 252 (hereinafter “slave”) is physically resident within the same hardware environment as the master server portion 254, yet functionally partitioned therefrom. The slave server portion 252 is profiled, using the methods described herein, as any other client device having resource configuration or functionality which is thinner relative to the master server.

The embodiment of FIG. 2a provides additional flexibility including, for example, the ability to dynamically configure the slave server portion 252 dependent on its required functionality and available resources, as well as the requirements/resources of the master server portion 254. Hence, functionality can be selectively “downloaded” to the thinner slave from the master in order to make more complete or efficient use of hardware resources with the server hardware environment containing both server portions, akin to a “load balancing” process commonly employed between discrete servers. Such download from master to slave may be accomplished in any number of ways, such as by downloading an application or components as a whole, or alternatively incrementally downloading additional functionality from the master to the slave and subsequently testing after each download for the required functionality of the downloaded portion. Allocation of the distributed application between the master and slave may be based on information or data derived from the master server portion (e.g., a resource message periodically generated by the master and transmitted to the slave), or any other compatible technique, including those described in Assignee's co-pending U.S. patent application “Method and Apparatus for Balancing Distributed Applications” previously referenced herein. Furthermore, it will be recognized that the aforementioned allocation may be dynamic and bidirectional if desired; e.g., the slave portion may shed functionality previously downloaded to it or otherwise resident as the resources available to it are depleted (or conversely, the resources available to the master are expanded).

FIG. 2b is a block diagram illustrating yet another embodiment of the distributed application profiling entity server portion (DASP), wherein the slave server portion 252 disposed within a different server device 260 acts as a client to the “master” server portion 254 as previously described. Here, the slave portion 252 is physically disparate from the master, such as by residing on a separate server device in a common server “farm”, or alternatively on a separate server device in a different server farm.

It will be recognized that many other permutations of the “master/slave” profiling relationship described herein may be utilized consistent with the invention. For example, a hybridization of the architectures of FIGS. 2, 2a, and 2b may be used, such as in the case where the slave server portion 252 of FIG. 2a has a slave portion (not shown) of its own disposed on the same or another server device. Such “serial slaving”, downloads from the original master portion 254 to the first slave 252 based on profiling of the first slave by the master may be subsequently propagated (e.g., copied, or selectively “passed through” without utilization by the first slave) to the second slave by the first slave, based on the latter's profiling of the second slave.

Similarly, the second slave(s) may be co-located (e.g., as partitioned server portions) within the first slave portion(s), the latter being disposed physically apart from the master server portion. Profiling of each of the individual “second slaves” may be conducted by its respective master (i.e., the first slave), and analyzed or transmitted to the master as part of the profiling process, the download from the master to the first slaves effectively contemplating and allocating for the subsequent downloads from the first slave(s) to their second slave portions.

As illustrated in FIG. 3, the profiling entity 205 of the present invention also includes a profiling manager unit (manager DASP) 302 disposed on each server 206 running the profiling entity. The manager DASP 302 creates the DASPs that communicate directly with the DACPs in the client devices. The DASP 302 also creates the subscriber management system (SMS) monitoring DASP 304 that creates the initial profiles for all of the client devices 208 by reading an SMS database 306 and writing profile records to the DAB database 212. The SMS monitoring DASP 304 reports to the manager DASP 302 every time it adds, modifies, or removes a client device record from the system profile. After the initial system profile is created, the SMS database 306 is monitored for changes, and the system profile modified accordingly. In certain cases client profiling and SMS records can be stored in or as part of the same database, to reduce redundant data storage and maintenance. When a client device record is added to the system profile, the manager DASP 302 forwards the information to a client controlling DASP 308. Each client controlling DASP 308 controls one or more DACPs 204.

### Method of Profiling

Referring now to FIG. 4, the method of profiling networked client devices according to the present invention is described. In one exemplary embodiment, this profiling method is embodied in the aforementioned software functional profiling entity 205 distributed across the network, the specific attributes and functionality of which are described in greater detail below.

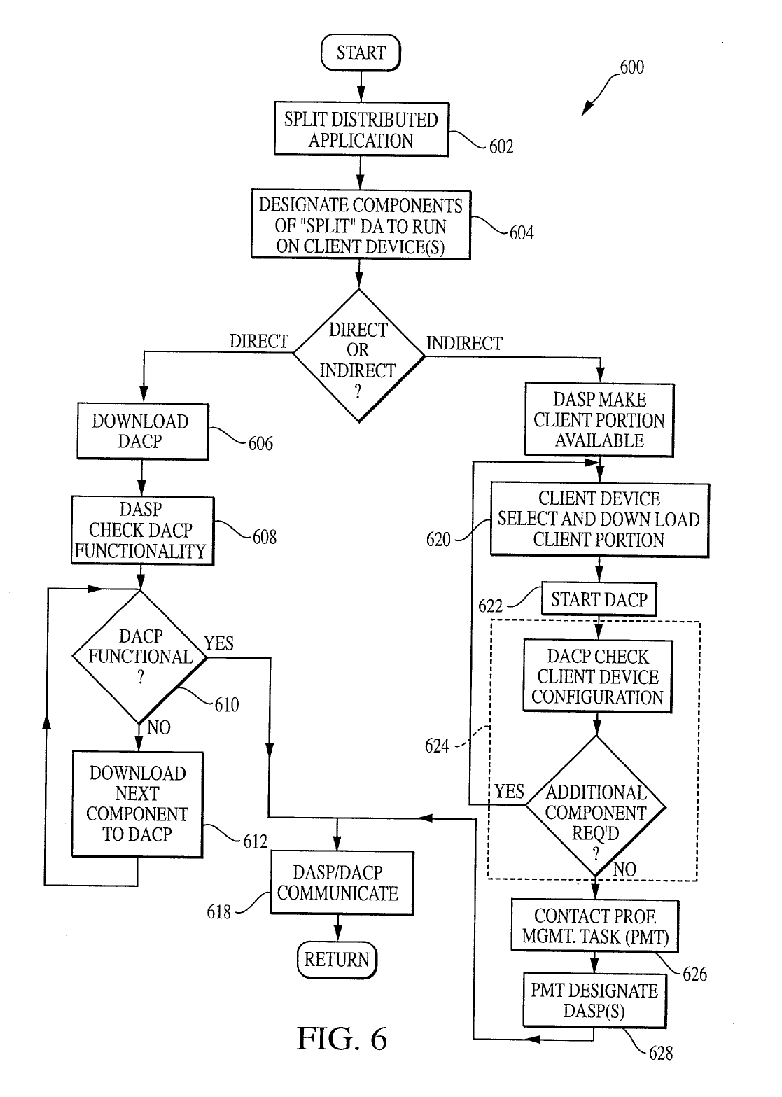

The first step 402 of the method 400 of FIG. 4 comprises downloading a client portion of the DA associated with the profiling entity 205 to one or more clients in the network. Methods of determining which portions of the profiling entity 205 to download is described in greater detail with respect to FIGS. 5 and 6 herein, although other methods may be substituted.

Applications can be downloaded to client devices in any number of ways. For example, in one embodiment, the client portion of the DA is reduced to one or more files present in circulating “file carousels” accessible via one or more communications channels. As is well known in the art, a carousel may be viewed as a directory containing files. The files of the carousel utilized herein are sent in a continuous round-robin fashion. If the client device misses a desired or necessary file in one carousel transmission, it can wait for the next. Alternatively, in another embodiment, the client portion is configured as part of the program content on a given in-band channel. As yet another embodiment, the client portion is downloaded directly using IP (Internet Protocol) packet traffic in an Out-Of-Band channel. Note that the file carousel or other device providing the client portion to the client device via the aforementioned communication channels may be the server 206 previously described, or alternatively a separate device which may or may not be physically co-located with the server. For example, a remote file storage device (not shown) with carousel capability may be in data communication with the client device(s) via an out-of-band communications channel as described below, the download of the client portion files from the remote device being initiated by way of a query from the client device, or alternatively a signal generated by the server 206 and transmitted to the remote device. Many other permutations of the foregoing system components and communication methods may also be used consistent with the present invention, as will be recognized by those of ordinary skill in the field.

As illustrated in the exemplary method 450 of establishing a communication channel for downloading of FIG. 4a, the client portion may be transmitted using in-band or out-of-band (OOB) techniques defined by OpenCable's OCI-N Cable Network Interface Standard (IS-N-INT02-000314) and the Society of Cable Telecommunications Engineers' Digital Cable Network Interface Standard (SCTE DVS/313r4) which are well known in the digital cable television arts, the relevant portions of which are incorporated herein by reference. These standards specify the Out-Of-Band Forward Data Channel (OOB-FDC) and Reverse Data Channel (OOB-RDC) as primary communications paths for client applications. If the head-end supports OOB-RDC traffic (step 452), the server DASP 202 will download the DACP 204 with an OOB “add-on” module (step 454). If able, the DACP 204 will respond on the OOB-RDC per step 456. If the DACP can communicate with the DASP 202 via the OOB-RDC the profiler communication link is established, and profiling processing may continue.

If the DASP 202 times out waiting for the DACP 204 to respond on the OOB-RDC per step 455, the DASP will download the Data Over Cable Service Interface Specification (DOCSIS) cable modem add-on module to the DACP if the head-end supports DOCSIS per steps 460 and 462. The DASP determines head-end communication capabilities using, inter alia, network capability queries to the head-end management system. If the head-end does not support OOB, but does support DOCSIS, the DASP 202 will download the DACP 204 with the DOCSIS add-on module per step 462. Based on the logic induced by the DA author, the add-on module could interface with the client device at the IP traffic level, which is transparent to the reverse data channel implementation. This would necessitate a single add-on module that could try and establish communications over either reverse data channel. If, in step 464, the DASP 202 times out waiting for the DOCSIS response it will download the telephone company (telco) modem add-on module per step 467 if the head-end contains a telco modem stack (step 466). If the head-end does not support OOB-RDC or DOCSIS, but does contain a telco (telephone voiceband) data modem stack, the DASP will download the DACP 204 with the telco modem add-on module per step 467. This process may continue (step 468) until a suitable communications channel is established, or another predetermined condition is met.

It is also important to note that a DASP which is not related to the DACP's application may indirectly download the DACP by causing it to be injected into a transport stream or other communications pathway at the head-end.

Referring again to FIG. 4, and after the download of the DACP 204 is complete per step 402, the downloaded client portion is executed or started per step 404. In the present embodiment, the Application Manager defined in the aforementioned OpenCable™ Standard performs this function. Additionally, a “started” message is generated and sent back to the DASP 202 per step 405. In all cases, the DACP is downloaded with the DASP's internet protocol (IP) address. Such IP address may take the form of the well-known IPv4 or IPv6 formats, although it will be appreciated that other formats may be used for the IP address. Using the DASP's IP address, the DACP is configured to send a User Datagram Protocol (UDP) start-up message to the DASP when it starts running. The DASP will send a UDP acknowledgement message that includes a session number, if/when it receives the DACP's message per step 406. UDP is used in the present embodiment instead of other protocols such as the Transport Control Protocol/Internet Protocol (TCP/IP) because the former is more efficient and because the increased robustness of TCP/IP is not necessary in a local head-end system. The profiling entity 205 of the present invention adds robustness by (i) including a session number, a transaction sequence number, and the time sent in each message; and (ii) acknowledging each message to the sender. Session numbers allow the DASP to verify the client sent a start message and allow redundant transaction Id numbers across multiple clients. Transaction Id numbers allow the same message to be re-sent without ambiguity. The sent time allows latency determinations to be made. Acknowledged messages are not again acknowledged in the present embodiment so as to avoid an infinite recursion.

It will also be recognized that the UDP protocol as described above may not be required depending on the specific application, or alternatively other methods of providing communications protocol may be utilized, whether alone or in combination with the foregoing methods. Such other communications protocols may include for example TCP/IP, HTTP, HTTPS, or SNMP which are well known in the communications arts, and accordingly are not described further herein.

Once the DACP is started, it queries the client device for its configuration information per step 408. Querying is accomplished in the present embodiment through the use of OpenCable compliant middleware calls within the client device. The DACP will receive a configuration information data structure and return it to the DASP. In the present context, the configuration information data structure contains fields that indicate information such as the hardware and/or software capabilities of the client device(s), data storage capacity, processor type/configuration, middleware version, or the existence of peripheral devices. The configuration information query of the illustrated embodiment is defined by the OpenCable standard, although other definitions may be applied. In the context of an exemplary digital cable television system, the query may comprise one or more calls to the OpenCable middleware.

Next, in step 410, the DACP 204 determines if it needs to make immediate configuration parameter or setup changes. This determination is based on programming determined by the DA author. Using the configuration information as a guidance tool, the DACP will also free (release, deactivate or exit from execution or activity) any add-on modules that it can't use for the client device that it is running on. Note that for bi-directional client devices, the DACP may be configured to send client device configuration information received by the DACP during the query of step 408 back to the DASP 202 if desired per step 412. In the illustrated embodiment, the receiving DASP(s) store the configuration information from all of the client devices in a central database 212 as shown in FIG. 2, although other storage schemes (including distributed storage across multiple databases or entities) may be utilized. For example, the configuration information may be stored in a plurality of remote databases disposed at one or more nodes of a network.

In step 414, the DASP optionally requests that the DACP make additional configuration or setup changes to the client device. If the client device is unidirectional (as determined in step 409) and can only receive messages or other information from the network (as is possible with the typical DSTB), then the profiling portion of the distributed application is placed on a channel to which the consumer can tune the client device per step 416. Alternatively, the information may be transmitted to the client device using the carousel approach previously described herein. It will be recognized that other methods of transmitting the information to the client device may be utilized as well if desired. When so tuned, the client device will download the client portion of the profiling entity 205 and start it as previously described. It will be recognized that a variety of different schemes for tuning the client device to the appropriate channel for DACP download may be utilized, including (i) having the consumer prompted, such as via visual and/or audio interface with the client device or other third party device, to manually tune the client device, (ii) having a service person perform the tuning during a periodic service call, or (iii) having an automatic tuning device which is keyed off an intrinsic or extrinsic signal, or based on a program adapted to dynamically determine proper tuning based on one or more inputs. The DACP is also optionally configured to display the configuration information on a display device associated with the client device, such as when prompted in an interactive fashion by the consumer.

In such unidirectional applications, transmission of the client configuration information to the MSO head-end operator can occur via a secondary communication channel, such as by having the consumer or service person relay the information by telephone, via a networked computer connection (such as by-e-mail), wireless data link, or any other number of well known methods. As used herein, the term “wireless data link” includes, without limitation, cellular telephone or other personal electronics connections, “Bluetooth™” 2.4 GHz interfaces, IEEE 802.11 wireless LAN interfaces, other direct sequence or frequency hopping spread spectrum interfaces, time modulated ultra-wideband (TM-UWB) links, synchronous optical networks (SONET), satellite links, and the like.

It is recognized that fully automated profiling of a client device may not always be possible or desirable. Accordingly, the present invention further provides the capability for a subset of the profile record fields for a given client device (or group of devices) to be determined manually. A partial profile record containing this subset of fields is optionally created at the MSO network head-end from information that is obtained from the Subscriber Management System. When the client device is installed, a network operator can derive the profile information from the installer via telephone, email, wireless data link, or other transmission or storage system. Note that as used herein, the term “installer” is not necessarily limited to a corporeal being disposed at the physical location of the client device, but rather may constitute a remotely located entity which is capable of controlling at least a portion of the attributes or functionality of the client device.

The network operator inputs the partial profile information received from the installer into the Subscriber Management System (SMS) prior to the execution of the first application on the newly installed client device. This partial profile information can be obtained from the SMS by other devices or personnel, and used to create a partial profile record, which can be used for load balancing in lieu of, or in addition to, the profile records that are derived dynamically from the client device during download or at runtime. The partial profile record can also be downloaded to the client device when the device is brought on-line. This download can be accomplished via OpenCable™ Standard processes as previously described.

The foregoing process is flexible in nature, and simplifies and shortens the time to bring a client device on-line. The load balancing mechanism, therefore, can advantageously (i) access the profiling information from the Subscriber Management System at each balancing occurrence, (ii) obtain the profiling information dynamically from the client device, and (iii) utilize the data previously stored in the profile record database.

### Scaling

An important feature of the present invention is its ability to download DACPs that will not over-burden the resource capabilities of the client device(s) on which it runs. Based on the variety of different possible distributed applications and client equipment configurations, it is necessary to provide a mechanism for “scaling” of the client portion, both at download/run-time and thereafter on an on-going basis.

In order to facilitate the creation of distributed applications for the profiling entity 205 described herein that will not over-burden the client resources, the present invention incorporates an interactive development environment (IDE) having an application authoring editor that provides application authors with the ability to specify how their applications are distributed. In the present invention, an application can be split using a plurality of tiers, such as for example that performed in the prior art CORBA system, wherein three tiers consisting of User Interface (UI), computational processing, and database are defined. However, the authoring editor of the present invention is configured to allow application authors to create as many or as few tiers as desired, thereby adding additional flexibility. In addition, the authoring editor of the present invention further permits so-called “vertical” splitting of the application as well as “horizontal” splitting as in the prior art tier system, as illustrated in FIG. 5. This ability to split the application both vertically and horizontally allows for the authoring of computationally intensive applications that can lend themselves to parallel processing in multiple CPU systems.

In the illustrated embodiment, the authoring editor provides for the definition of applications based on the object-oriented Unified Modeling Language (UML). UML is well known in the computer programming and software arts, and accordingly will not be described further herein. The use of an object-oriented language such as UML allows the authoring editor to be language independent at the design level. The authoring editor defines separate interfaces types for horizontal or vertical application distribution and defines an application programming interface (API) for each of the interface types.

The authoring editor further provides a framework generator that enables the use of “thread safe”, one-to-many relationships of the DASP and the DACP(s). “Thread safe” source code allows multiple threads to concurrently access the same resource (e.g., memory, object, etc.), without corruption of that resource. This framework generator generally comprises, inter alia, conventional framework generation capability (i.e., taking a high-level input diagram such as a flow chart and generating source code in a designated programming language which implements the diagrammed functionality, such as C++, Java™, etc.) with the added ability to “layer” multiple framework generators in an interactive fashion such that translation between multiple environments is achieved. Furthermore, the framework generator may be used to generate frameworks compatible with other framework generation entities such COM and COM+, Java Bean™, Jini, and even CORBA IDL. FIGS. 8 and 9 herein illustrate exemplary frameworks within the context of the distributed application of the present invention.

In the illustrated embodiment, each DA framework can be specified with one or more critical sections. As used herein, the term “critical sections” refers to a section of source code that accesses resource(s) in an exclusive fashion. Each critical section is protected from multiple DACP entry using a “test-and-wait” function (such as a semaphore in the illustrated embodiment) that will wait for the desired resource. As is well known in the art, a semaphore is a mechanism that is used to signal the availability of a resource. One or more processes may wait indefinitely for a resource semaphore to signal availability. The semaphore function of the present embodiment is also optionally configurable such that, if a resource is capable of handling access from multiple processes simultaneously, then the semaphore increments or “counts up” to the maximum number of processes before blocking access to the resource.

Alternatively, a queue may be used to implement the aforementioned test and wait functionality. A “queue” refers generally to an entity for inter-process communications and allows messages to be passed between DA portions on the same system. In the context of real-time operating systems, a queue is used for inter-process communication, each process typically having its own individual message queue. A given process can therefore post messages to any other process that creates its own queue. Many variations of inter-process “queues” are well known to those of ordinary skill in the art, and accordingly will not be described further herein.

Furthermore, it will be appreciated that other “test-and-wait” functions, and in fact other types of protection mechanism for the critical sections other than test-and-wait functions, may be substituted for the semaphore and queue approaches previously described herein with equal success.

Referring now to FIG. 6, the “run-time” scaling methodology 600 of the present invention is described in detail.

The IDE of the present invention allows DA authors to create applications that will automatically scale at run-time. As previously described, a DA is first split (step 602 of FIG. 6) along multiple functional fracture lines both horizontally and vertically, as shown in FIG. 5. All of the interfaces between these splits are defined using DA message protocol application programming interfaces (APIs), such APIs being well known to those of ordinary skill in the programming arts. The DA author, using the authoring editor, next specifies which pieces or components of the fractured DA are to run on the client device, which pieces are to run on the server, and which pieces can run on either (step 604). The components (DACPs) that can run on either the server machine or the client device are referred to as Mutable Objects. In the present embodiment, the application-specific load balancing modules of the server machines determine where the Mutable Objects will be loaded at run-time, although other approaches may be used. Each DA has a configuration file created by the DA author that is stored in the client device profile database and acted upon by system processes that instigate the DACP download. The load balancing modules compare the client device profile record to the application configuration file or record, and determine where to load the Mutable Objects based on the needs of the application and the current capability of the client device.

In the present embodiment, there are two methods by which a DACP may be downloaded to a client device, e.g., via DASP “direct” or “indirect.” A DASP may directly download a DACP to a client device by sending it to the device using a network technique such as IP traffic or MPEG traffic in the digital television embodiment. Alternatively, a DASP may indirectly download a DACP by placing it into a file carousel or other mechanism as previously described. This latter methodology is referred to as “indirect” download because the client device must select the DACP from the carousel to finish the download, as opposed to the “direct” techniques where the requisite DACP is sent directly to the client device.

In the direct download case, after the designated pieces of the client portion have been downloaded in step 606, the server portion checks for the functionality of the client portion in step 608. In one embodiment, if the server does not receive a “started” message or other acknowledgement as previously described from the client in step 610, it downloads the next functional component or “piece” of the fractured DA to the client device per step 612. The sequence of download of the DA components is determined by the Load balancer at runtime, using information dynamically obtained from the system at runtime, such as bandwidth availability for various communication paths and memory capacity of the targeted client device, and information provided by the DA author during development of the DA. For example, the DA author may specify that three sequential communications techniques will be utilized to establish functional behavior (i.e., communication with the DASP) within the DACP, as described in the exemplary configuration below. Each successive download makes the DACP 204 “fatter”, giving it more functionality. The server again checks the functionality of the client portion in step 610; e.g., if the “started” message or other acknowledgement is received, the download of further pieces of the DA is ceased per step 618. If not, the download of further components is continued per step 612 until client functionality (e.g., communication with the server portion 202) is achieved per step 618.

In the indirect download case, after the client device has selected the profiling DACP from the file carousel (step 620) and started the DACP (step 622), the running DACP checks the hardware capabilities of the client device (step 624) and selects add-on modules from the carousel that match the client device's capabilities. For example, as shown in FIG. 6, if the client device has a DOCSIS cable modem, the profiling DACP can download the DOCSIS add-on module from the carousel and use that source code to communicate with a profiling DASP. When the DACP starts it may not have the address of a DASP. To discover the DASP address, the DACP sends a multicast message to the profiling management task (step 626). This task will select an appropriate DASP (step 628), or start a new one if an existing DASP is not available. The management task will forward (proxy) the DACP start message to the DASP. The DASP will then respond directly to the DACP and send it its session number to establish communications (step 618).

It will be recognized that while the present discussion of the method of FIG. 6 is cast in terms of discrete communications modules which are sequentially downloaded to the client device as needed in order to establish communications with the DASP, the sequence of download, types of components downloaded, and definition of functionality required to terminate further downloads of the components may vary. For example, the required functionality of the DACP may comprise generation of an image on the display device of the client device, which is accomplished by way of successive downloads of various types of video or image processing modules, and communicated back to the DASP via an unrelated communications channel. As another alternative, electronic-commerce applications may contain portions that can run on the client device or the server machine, based on the capabilities of the client device. One such portion could be the purchasing component for prompting the end user and acquiring a payment method. Many such alternate configurations are possible, all being considered to fall within the scope of the claims appended hereto.

To provide information necessary to perform profiling after application program start, the present invention utilizes the client portion of the profiling entity 205 to initially send the client device configuration information to the DASP, and then continue to periodically send dynamic profile information. The DACP of the profiling entity 205 continues to run at a low priority in the background on the client device. It also determines if any changes in the client device configuration have occurred by registering for configuration changed events and periodically querying the middleware. In addition, the profiling entity client portion periodically runs performance tests to determine the availability of resources such as CPU, memory, input/output (I/O), or algorithmic processing. If significant changes or changes of a predetermined type are detected by the DACP, information regarding these changes is sent to the DASP 202 automatically (in a bi-directional client device), at a predetermined interval, upon the occurrence of a specific software or hardware event, or alternatively a prompt to the client device user will be generated to inform the network operator of the changes (in a unidirectional client device). In addition, the DASP may contact the DACP to modify client device configuration parameters at application runtime.

The DASP 202 is also configurable to store the results of these performance tests over time and calculate statistics based thereon. The statistics are stored in the database 212 so that other applications and system processes can determine how best to distribute DACPs and add-on modules to various client devices. Methods for allocating head-end server resources and distributing DACPs and other modules are described in detail in the aforementioned co-pending patent application previously incorporated herein. The compilation and analysis of performance-related statistics may be accomplished using any number of data processing and analysis techniques well known in the data processing arts, and accordingly will not be described further herein.

### Example

As an example of the foregoing aspects of the invention, a digital cable television network constrained to the OpenCable™ standard is described. In this exemplary network, three possible methods by which a client device connected to an HFC cable, can transmit data back to the head-end exist: 1) where both the head-end and the client device have DOCSIS cable modem capabilities; 2) where both the head-end and client device have Out-Of-Band Reverse-Data-Channel (OOB-RDC) capabilities; and 3) where both the head-end and client device have telco modem capabilities.

When the head-end and client device have matching capabilities for either cable modem or OOB-RDC functionality, the aforementioned OpenCable standard defines an automatic method for client device network address realization. In the cable modem case, the Dynamic Host Control Protocol (DHCP) is used. In the OOB-RDC case, proprietary messaging between the Conditional Access (CA POD) and the head-end are employed. In both cases the client device receives an IP address for the particular interface.

When the head-end and client devices have matching telco modem capabilities only, the modem configuration parameters can be sent to the client device using OOB-FDC, or manually entered into the client device by a cable company installer or the client device owner (consumer). The telco modem includes the phone number to dial into the head-end, the baud rate of the connection, parity, etc. In addition, a connection message can be configured in the client device so that it sends a unique name or identifier to the head-end for identification purposes.

In terms of the head-end database, the profiling entity 205 establishes a consumer-specific database record in the head-end Subscriber Management System (SMS) of FIG. 3. This record contains, inter alia, the consumers account information, viewing authorizations, client device information entered manually, as well as other information relating to the given consumer. The profiling unit has access to the SMS database, and maintains a profile entry for each of devices in the SMS database. Furthermore, a dynamic record is maintained by the profiling unit indicating whether or not each client device has been successfully contacted and which protocol was used to contact it. Database record management techniques are well known to those of ordinary skill in the art, and accordingly will not be described further herein.

The head-end of the present exemplary system further includes yet another database or file for each segment of client devices. As used herein, the term “segment” refers to a group of client devices connected to the same network hub and having the same sub-net portion in their IP addresses. The number of client devices in each segment is determined by the hardware capabilities of the network, although alternative schemes for grouping may be employed. For DOCSIS, a Cable Modem Termination System (CMTS) of the type well known in the art is used for each segment. Similarly, for OOB-RDC, one or more OOB servers are utilized for each segment. For telco modems, one or more modem stacks are utilized for each segment. Note that typically, the parent telephone company will identify the telco modem segments. Furthermore, the system maintains databases or files for each of the communication protocols used within the system. For example, the cable modem system utilizes a Dynamic Host Configuration Protocol (DHCP) database. As is well known in the art, the DHCP protocol is a protocol for automating the configuration of computers that use IP traffic. The OOB-RDC system is proprietary to the MSO and may use DHCP or the Bootstrap Protocol (BOOTP) files. Bootstrap protocol, as the name implies, allows a network user to be statically configured, including receiving an IP address. Note that in the present embodiment, BOOTP is used for IP address discovery only, and if skipped the operating system will still “boot.” The telco modem system of the present example utilizes a telco proprietary database, although other types may be substituted.

The profiling entity 205 further has access to all of the databases and files necessary to identify and communicate with every client device in the network. Because some of these interfaces can be proprietary in the head-end, the profiling unit DASPs are configured to provide a portable API and templates for common interfaces. The DASP can be authored with two types of interfaces (a.k.a. partitions); specifically, (i) Peer interfaces, and (ii) Client/Server interfaces. Peer partitions are proprietary to the head-end and are implemented by the MSO. Client/Server partitions come standard with the DASP and DACP frameworks IDE. Each DA will have a DASP and a DACP framework that act as anchor points that do not move. In between them may be multiple modules that can move between the server and client and tasks therein. The movable modules are therefore mutable. The DASP and DACP anchor points may have an arbitrary number of Peer and Client/Server partitions. The mutable modules may have an arbitrary number of Client/Server partitions only. When a mutable module is placed in the same task context as an anchor point or other mutable module, object oriented techniques for polymorphism and method over-riding can be employed such that calls made to the mutable object directly invoke its methods rather than sending a message to it across a network. This form of scaling directly increases the performance of the DA for clients that can support mutable modules. Mutable modules and anchor points are described in detail in the aforementioned co-pending patent application previously incorporated herein.

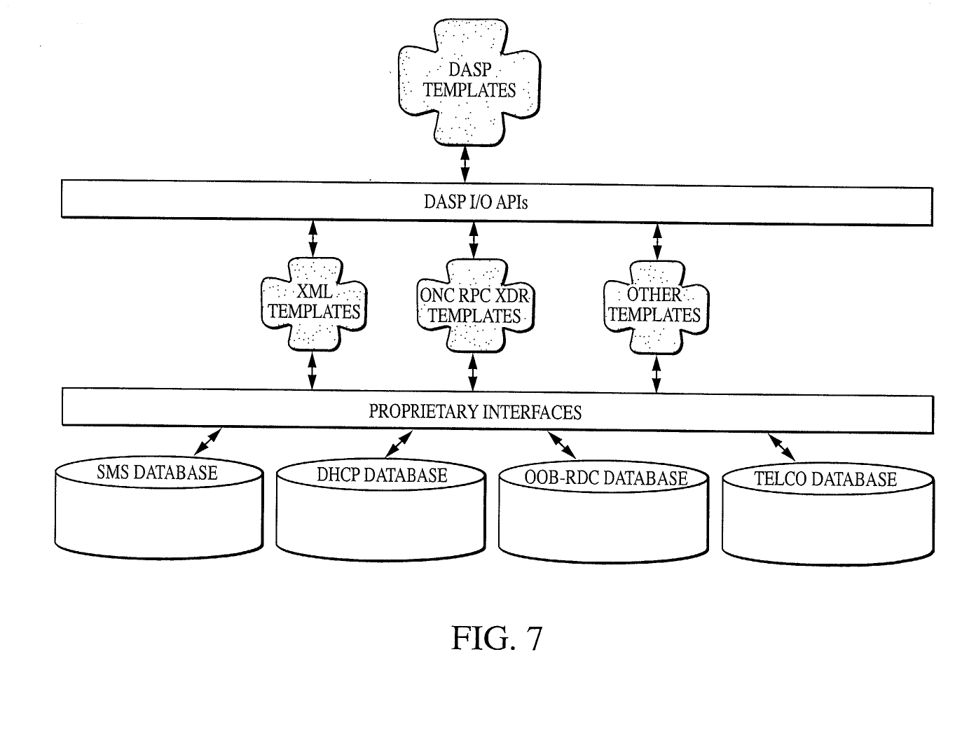

The implementation details of whatever communications protocol are being used is transparent to the API. The templates are layered underneath the API, to allow rapid porting to any head-end system. Templates are provided that incorporate well, known, industry standard I/O techniques. Such industry standard I/O techniques include, inter alia, Open Network Computing (ONC) Remote Procedure Calls (RPC) and eXternal Data Representation (XDR), the eXtensible Markup Language (XML). It will be recognized, however, that templates for non-standardized or proprietary I/O interfaces may also be employed, whether alone or in combination with the aforementioned templates, if desired. FIG. 7 illustrates the relationship of the APIs and templates of the present embodiment.

It is lastly noted that many variations of the methods described above may be utilized consistent with the present invention. Specifically, certain steps are optional and may be performed or deleted as desired. Similarly, other steps (such as testing, signal processing or conditioning, and calibration, for example) may be added to the foregoing embodiments. Additionally, the order of performance of certain steps may be permuted, or performed in parallel (or series) in certain cases if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method of characterizing a processing device in a network having at least one first data processing device and at least one second processing device in data communication therewith, comprising:
downloading at least a portion of a distributed application to said at least one second processing device;
starting said downloaded portion;
querying said at least one second processing device for configuration information; and
transmitting at least a portion of said configuration information to said at least one first processing device.

2. The method of claim 1, wherein said at least one first data processing device comprises a server, and said at least one second processing device comprises a client device coupled to said server via a network, and said act of downloading comprises transferring said at least portion of said distributed application to said at least one client device via a communication channel associated with said network.

3. The method of claim 2, wherein said network comprises a cable network, and said communication channel comprises an out-of-band (OOB) channel.

4. The method of claim 1, wherein said act of downloading comprises downloading said at least portion from a third device in data communication with said at least one second processing device.

5. The method of claim 4, further comprising:
transmitting at least one signal from said at least one first processing device to said third device; and
initiating said act of downloading based at least in part on said signal.

6. The method of claim 5, wherein said act of transmitting at least one signal comprises transmitting said at least one signal over said network.

7. The method of claim 1, wherein said act of querying comprises:
transmitting a first message from said at least one first processing device to said at least one second processing device; and
initiating, in response to said first message, a routine within said at least one client device adapted to determine said configuration information.

8. The method of claim 1, wherein said act of querying comprises issuing a middleware call.

9. The method of claim 7, wherein said act of transmitting at least a portion of said configuration information comprises:
generating a message according to a predetermined format, said message comprising said at least portion of said configuration information; and
transmitting said message to said at least one first processing device via a communication channel.

10. The method of claim 1, wherein said act of transmitting at least a portion of said configuration information comprises:
generating a message according to a predetermined format, said message comprising said at least portion of said configuration information; and
transmitting said message to said at least one first processing device via a communication channel.

11. The method of claim 10, wherein said act of transmitting said message comprises transmitting said message via a communication channel other than said network.

12. A method of characterizing a processing device in a network having at least one server and at least one client device in data communication therewith, comprising the steps of:
providing a distributed application having at least a server portion and a client portion, said distributed application being initially disposed at said at least one server;
downloading said at least client portion of said distributed application to said at least one client device to provide said at least client device with a predetermined functionality;
starting said downloaded client portion;
querying said at least one client device to obtain configuration information therefrom using said client portion; and
generating a data structure containing at least a portion of said configuration information in response to said act of querying.

13. A method of dynamically allocating a distributed application between a server and at least one client device, comprising:
providing said distributed application comprising a plurality of components;
selectively downloading at least a first component of said distributed application from said sever to said at least one client device;
determining the functionality of said at least one client after said downloading is completed; and
successively downloading individual additional components of said application, and testing the functionality of said client thereafter each such successive download, until said client is determined to be functional.

14. The method of claim 13, wherein the act of determining the functionality comprises determining whether data may be transmitted between said at least one client device and said server via at least one communication channel.

15. The method of claim 14, wherein said first component comprises an out-of-band (OOB) communications module.

16. The method of claim 15, wherein said additional components comprise a cable modem (DOCSIS) communications module and telco modem communications module.

17. A method for operating a client device in a network having a server and a client device, comprising:
downloading a portion of a distributed application to said client device;
initiating a software routine for starting said downloaded portion;
querying said client device for configuration information using at least said downloaded portion; and
generating said configuration information specific to said client device.

18. The method of claim 17, further comprising configuring said client device based at least in part on said configuration information.

19. The method of claim 18, further comprising transmitting said client device configuration information to said server, and wherein the act of configuring comprises selectively downloading one or more additional distributed application components based on said transmitted configuration information.

20. Apparatus for profiling at least one client device, said at least one client device being operatively connected to a data network, comprising:
server means in data communication with said network;
means for communicating data to said client device means for determining the configuration of said client device, said means for determining being movable to said client device via said means for communicating;
means for transmitting said means for determining from said server means to said client device;
means for transmitting information regarding said client device configuration to said server means;
means for receiving said client device information at said server means; and
means for storing at least a portion of said client device information.

21. An apparatus for dynamically obtaining the configuration of a client device connected to a data network, comprising:
at least one server in data communication with said network;
a distributed application having at least a server portion and a client portion, said at least client portion being movable between said server and said client device, said at least client portion being adapted to communicate with said at least server portion;
a storage device operatively coupled to said at least one server;
wherein said at least client portion is adapted, when moved to said client device, to obtain configuration information regarding said client device, and transmit said configuration information to said server for storage in said storage device.

22. The apparatus of claim 21, wherein said at least server portion of said distributed application is further adapted to analyze said configuration information received from said client device, and determine, based on said analysis, additional software components to be downloaded to said client device.

23. A method of transferring configuration information relating to a processing device in data communication with a network, comprising:
querying said processing device using a first software process;
generating a data structure in response to said act of querying using a second software process, said data structure comprising a plurality of data fields, each of said fields comprising a plurality of data bits, wherein combinations of said bits within each field indicate configuration information related to said processing device.

24. A distributed application for use on a data network, comprising:
at least one server portion disposed on at least one of a plurality of servers of said network, said at least one server portion comprising a plurality of modules;
at least one client portion disposed on at least one of a plurality of client devices of said network, said at least one client portion comprising at least one module, and being adapted to obtain configuration information from said at least one client device and generate a data structure containing at least a portion of said configuration information;
at least one mutable module, said mutable module being adapted to run on either at least one of said plurality of servers or at least one of said plurality of client devices;
wherein said at least one mutable module is adapted to maintain at least one network partition.

25. The distributed application of claim 24, wherein said at least one server portion is further adapted to receive said data structure and recognize said configuration information.

26. The distributed application of claim 24, wherein the location of said at least one mutable module is determined at least in part by said configuration information.

27. A method of configuring a client-server network having server resources and a plurality of client devices, and a distributed application adapted for use thereon, comprising:
providing a first process running within said server resources, said first process configured to obtain data relating to the usage of said server resources;
receiving, at said server resources, a server resource request from a client device;
selecting a server within said server resources based at least in part on said data from said first process;
starting a server portion of said distributed application on said selected server;
downloading a client portion of said distributed application to said client device from said selected server;
starting said downloaded client portion at said client device;
querying said client device using said downloaded client portion to obtain configuration information relating thereto; and
downloading at least one software module to said client device based at least in part on said configuration information.

28. A client device adapted for use on a data network, comprising:
a processor adapted to process digital data;
a first software routine configured to run on said processor, said first software routine being adapted to communicate with a corresponding software routine running on a remote processing device which is in data communication with said client device, said first software routine being further adapted to be movable between said remote processing device and said client device;
a second software routine configured to run on said processor, said second routine being adapted to determine information relating to the configuration of said client device and generate a data structure containing at least a portion of said information therein;
a storage device adapted to store digital data, said storage device being in data communication with said processor and capable of storing said data structure;
wherein said data structure may be transmitted to said remote processing machine.

29. The client device of claim 28, wherein said first software routine is adapted to query said second software routine to determine said information.

30. The client device of claim 29, wherein said query comprises an OpenCable middleware call.

31. A method of configuring a client device in a network having a server and at least one client device, comprising:
downloading a portion of a distributed application to said at least one client device;
initiating said downloaded portion;
querying said at least one client device for configuration information using at least said downloaded portion;
generating said configuration information specific to said at least one client device; and
re-configuring said at least one client device using said downloaded portion and said configuration information.

32. Apparatus, comprising:
at least one server, said server having at least one first server portion of at least one distributed software application running thereon;
at least one client device, adapted for communication with said at least one first server portion via a data network, said at least one client device being further adapted to run at least one client portion of said at least one distributed software application thereon;
wherein said at least one client portion is configured to determine at least a portion of the hardware configuration of said client device and transmit information regarding said at least portion to said at least one first server portion.

33. The apparatus of claim 32, wherein said client device comprises a second server portion running on said at least one server.

34. The apparatus of claim 32, wherein said client device comprises a second server portion running on a second server.

35. The apparatus of claim 34, wherein said second server comprises part of the same server farm as said at least one server.

36. The apparatus of claim 33, wherein said second server portion is configured to communicate with a second client device.

37. The apparatus of claim 36, wherein said second client device is adapted to receive and run at least a portion of said distributed application.

38. The apparatus of claim 33, wherein said second server portion communicates with said first server portion using messages transmitted from said second server portion to said at least one first server portion, said messages utilizing a predetermined communications protocol.

39. The apparatus of claim 36, wherein said second client device communicates with said at least one first server portion using messages transmitted from said second client device to said at least one first server portion, said messages utilizing a predetermined communications protocol.
